(19) United States
(12) Patent Application Publication
(10) Pub. No.: US 2009/0007967 A1
(43) Pub. Date: Jan. 8, 2009

(54) Method of Coating a Pipe Element or Device Used to Convey Gaseous Oxygen

(76) Inventors: Emmanuel Fano, La-Varenne-Saint-Hilaire (FR); Alain Colson, Saint-Maur (FR)

Correspondence Address: AIR LIQUIDE;Intellectual Property, 2700 POST OAK BOULEVARD, SUITE 1800, HOUSTON, TX, 77056, US

(21) Appl. No.: 11/817,489

(22) PCT Filed: Feb. 13, 2006
(86) PCT No.: PCT/FR2006/050123

§ 371 Date: Jul. 31, 2008

(30) Foreign Application Priority Data
Mar. 3, 2005 (FR) 0550565

(51) Int. Cl. F17D 1/04; C23C 4/08; C23C 4/02

(52) U.S. Cl. 137/12; 427/456; 137/561 R

(57) ABSTRACT

The invention relates to a method of producing a device or an element belonging to a piece of equipment that is made from steel or a steel alloy, which may come into contact with pressurised oxygen during the use thereof. The inventive method consists in producing a coating by thermally spraying a spray material that is selected from among nickel and the alloys of copper and nickel on at least part of the surface of the element or device, such as to obtain at least one coating layer on said surface, having a thickness of less than or equal to 5 mm.

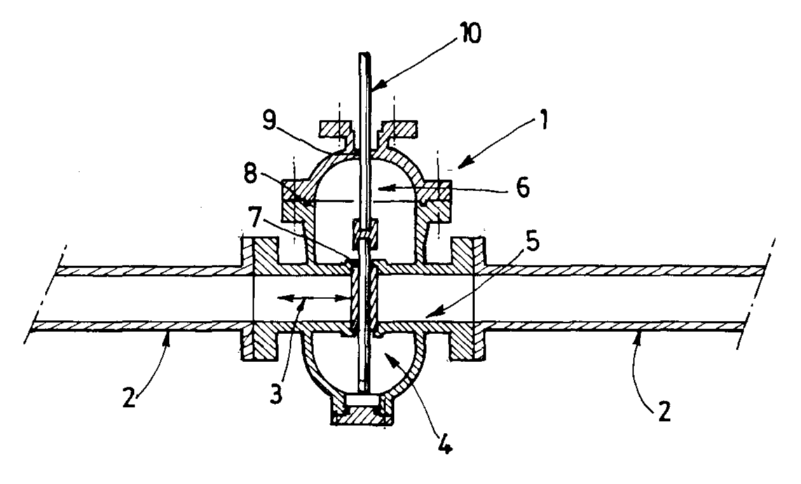

The present invention relates to a method for coating in a thick layer, applicable to items of equipment of gaseous oxygen pipelines.

Items of equipment and accessories of gaseous oxygen pipelines, such as valves, taps, non-return valves, filters, tubes, flanges or the like, are currently and traditionally produced in materials of the steel type that are alloyed, lightly alloyed or not alloyed.

The most currently used materials are steels, called “carbon steels” or stainless steels.

These materials enter into the composition of bulky components of these items of equipment, such as for example the body or envelope of such equipment or other components of which it is made.

Alloys with a high nickel and/or copper content of the Monel or cupro-nickel type are much more rarely employed on account of their very high cost and application difficulties that are peculiar to them.

The components constituting the envelope under pressure, that is to say mainly the body, the cap, the flanges or the like, of each item of equipment of a gaseous oxygen pipeline are generally composed of one or more monometallic homogenous materials.

Now, carbon steels or stainless steels that enter into the composition of these bulky components have the major disadvantage, in terms of safety in use, of their ability to maintain and propagate combustion in the presence of oxygen and as a function of pressure. The concept of exemption pressure is a reference value within the meaning of CGA 4.4 and IGC 13/02 and is situated for a steel between 0.2×10⁶ Pa and 2.6×10⁶ Pa (=2 and 26 barg=29 to 375 Psig) according to the grade and thickness.

On the other hand, nickel, copper and alloys with a very high nickel copper content, that is to say typically containing at least 60% by weight of nickel or copper, have an exemption pressure of the order of 200 bar, or even greater in some cases according to the composition of the material, and have the property of not maintaining or propagating combustion.

On account of this, in order to prevent and minimize risks, it is usual in the industrial field, for items of equipment made of steel assembled on oxygen pipelines, to limit the maximum service pressure to a level less than the exemption pressure, or to install equipment behind barriers or other means of protection for the surrounding personnel and installation, or to use the abovementioned suitable exemption materials.

However, these solutions are far from satisfactory since, first of all, the use of steel can lead to an incident of the “flash back” type, even inside a protective chamber, and to the production of considerable damage and, secondly, the use of materials different from steel involves much higher manufacturing costs and often complicates the actual manufacture of items of equipment, since use of these materials is more difficult than it is with steels.

The following documents are additionally known that describe the production of various coatings:
U.S. Pat. No. 6,089,828 teaches the formation on a gas turbine element of a wear-resistant coating formed of an aluminum alloy and bronze.
JP-A-57070306 and U.S. Pat. No. 2,300,400 describe coatings formed of alloys of the nickel/chromium type.
EP-A-825 272 relates to the production by hot spraying of a coating of copper, lead and bronze.

JP-A-2001323361 provides coatings based on a nickel/aluminum alloy.

However, all these solutions do not make it possible to solve the abovementioned problems.

The problem that is presented is then to provide an item of equipment or an element of such item of equipment designed to be arranged on a pipeline conveying oxygen under pressure that does not have the abovementioned risks and disadvantages of equipment of the prior art.

The solution of the invention is then a method for producing an item of equipment or an element of an item of equipment made of steel or of a steel alloy, capable of being put into contact with oxygen under pressure during its use, in which a coating is produced by thermal spraying of a spraying material on at least part of the surface of said element or item of equipment so as to obtain at least one layer of a coating on said surface with a thickness less than or equal to 5 mm, characterized in that the spraying material is chosen from nickel and alloys of nickel and copper.

In other words, according to the method of the invention, at least one protective layer, formed of nickel or of a nickel/copper alloy, is deposited on the surface of the item of equipment or of the element of the item of equipment made of steel or of a steel alloy, this surface being capable of being put into contact with oxygen under pressure during its use, so as to protect this surface by means of one or more protective layers and in this way to avoid the abovementioned problems.

According to the case, the method of the invention can comprise one or more of the following features:
a coating is produced with a thickness of 0.1 mm to 5 mm
said element or item of equipment is made of steel, cast iron or stainless steel.
said element or item of equipment has a cavity or internal passage, and said coating is carried out on at least part of the internal wall of said cavity or of said internal passage.
the spraying material is of nickel or of an alloy consisting mainly of nickel and copper and can additionally include certain alloying elements such as chromium or cobalt.
the spraying material is pure nickel or nickel/copper alloy (NiCu) comprising up to 60% by weight of copper, the remainder being nickel.
the coating is produced by thermal plasma spraying, that is to say by a method of the “blown plasma”, APS (Air Plasma Spray) or HVOF (High Velocity Oxy Fuel) type.
the coating is produced by blown plasma using a gas chosen from argon, hydrogen, helium and nitrogen as the carrier gas.
a coating is produced of an additional protective layer of a totally oxidized second material, preferably of the ceramic type. Indeed, three elements are needed to bring about combustion, namely an oxidant, a fuel and energy. On account of this, it may be necessary in critical locations to add a second layer of oxides that will create a thermal barrier and will reduce heating by friction or abrasion (energy) which will then improve safety.
said new or existing item of equipment is chosen from the bodies of valves, parts of revolution or any other items of equipment of a gaseous oxygen pipeline.

The invention also relates to an item of equipment or an element of equipment, for example a single element of pipework, such as a flange, a straight section, a side branch, an elbow, a T, a reduction pipe etc., designed to be put into contact with oxygen under pressure during its use, comprising a body made of steel or of a steel alloy, characterized in that it comprises at least one layer of a coating in a material chosen from nickel and alloys of nickel and copper, over at least part of the surface of said body, said coating layer having a thickness less than or equal to 5 mm.

In addition, the invention also relates to a method for conveying oxygen under pressure employing at least one oxygen pipeline in which oxygen is conveyed under pressure, characterized in that an item of equipment or an element of equipment, for example an element of pipework, according to the invention or obtained by the production method according to the invention, is arranged on said pipeline and is put into contact with oxygen under pressure circulating in said pipeline.

In other words, the invention consists of improving safety of items of equipment made of steel or of steel alloy designed to be used in contact with oxygen and proceeding to a coating in one or more layers, typically from 1 to 5 mm, by thermal spraying of an exemption material of the nickel or nickel/copper and/or oxides type onto the inner or outer walls subjected to the pressure of oxygen, of any item of equipment or element of equipment, in particular pipework, designed for service with oxygen.

Preferably, the mechanical interfaces of the equipment are coated, whether this be a new item of equipment or a worn item that has to be improved.

Following the coating procedure according to the invention, the apparatus or item of equipment treated in this way can be used in service with oxygen under the following conditions:
the oxygen contained in the apparatus in service can be less than or equal to 100%,
the service pressure of the apparatus in service can be a maximum of 50×10⁶ Pa (500 bara) but typically at least 25×10⁶ Pa (250 bara), and
the service temperature of the apparatus is situated between −40° C. and +200° C.

The apparatus or item of equipment treated in this way thus has the same conditions of safety and reliability as the same apparatus made of solid exemption material.

An example of an embodiment of the invention is given in the appended figure which represents a full-bore valve 1 of the “gate” type with a control rod 10 (here in the closed position) commonly used on oxygen pipelines 2 of which the safety has been improved by means of the present invention.

More precisely, a coating of nickel has been produced on the inner surface 4,5,6 of the valve 1, that is to say on the surface 4,5,6 coming into direct contact with oxygen 3 during the use of the valve 1 and on the interfaces of the mechanical connection to be coated 7,8,9.

This nickel coating was formed with the deposition method by thermal spraying of the above mentioned “blown plasma” type. It should be noted that this coating also makes it possible to repair any porosities in the base material.

As mentioned above, the present invention is not limited to the coating of a valve but applies to any element or item of equipment serving to convey oxygen under high pressure.

1-11. (canceled)

12. A method for producing an item of equipment or an element of an item of equipment made of steel or of a steel alloy, capable of being put into contact with oxygen under pressure during its use, in which a coating is produced by thermal spraying of a spraying material on at least part of the surface of said element or item of equipment so as to obtain at least one layer of a coating on said surface with a thickness less than or equal to 5 mm, wherein the spraying material is chosen from nickel and alloys of nickel and copper.

13. The method of claim 12, wherein a coating is produced with a thickness of about 0.1 mm to about 5 mm.

14. The method of either of claims 12, wherein said element or item of equipment is made of steel, cast iron, or stainless steel.

15. The method of claim 12, wherein said element or item of equipment has a cavity or internal passage, and in that said coating is carried out on at least part of the internal wall of said cavity or of said internal passage.

16. The method of claim 12, wherein the spraying material is nickel or a nickel/copper alloy comprising up to about 60% by weight of copper, the remainder being nickel.

17. The method of claim 12, wherein the coating is produced by blown plasma, APS, or HVOF.

18. The method of claim 12, wherein the coating is produced by blown plasma using a gas chosen from argon, hydrogen, helium, and nitrogen as the carrier gas.

19. The method of claim 12, wherein a coating is produced of an additional protective layer of a totally oxidized second material, preferably an additional ceramic layer.

20. The method of claim 12, wherein said element or item of equipment is chosen from the bodies of valves and parts of revolution or any other item of equipment, including elements of pipework, of a gaseous oxygen pipeline.

21. An item of equipment or an element of an item of equipment, in particular an element of pipework, designed to be put into contact with oxygen under pressure during its use, comprising a body made of steel or of a steel alloy, wherein it comprises at least one layer of a coating in a material chosen from nickel or alloys of nickel and copper, over at least part of the surface of said body, said coating layer having a thickness less than or equal to 5 mm.

22. A method for conveying oxygen under pressure employing at least one oxygen pipeline in which oxygen is conveyed under pressure, wherein an item of equipment or element of an item of equipment of claim 21, is provided on said pipeline and is put into contact with oxygen under pressure circulating in said pipeline.

23. A method for conveying oxygen under pressure employing at least one oxygen pipeline in which oxygen is conveyed under pressure, wherein an item of equipment or element of an item of equipment obtained by the method of claim 12, is provided on said pipeline and is put into contact with oxygen under pressure circulating in said pipeline.
